(19) United States
(12) Patent Application Publication
(10) Pub. No.: US 2006/0146045 A1
(43) Pub. Date: Jul. 6, 2006

(54) Apparatus and method for controlling power of a liquid crystal display in a mobile communication terminal

(75) Inventor: Chun-Soo Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/292,032

(22) Filed: Dec. 1, 2005

(30) Foreign Application Priority Data
Dec. 1, 2004 (KR) 2004/0099670

(51) Int. Cl. G09G 5/00

(52) U.S. Cl. 345/211; 307/43

(57) ABSTRACT

An apparatus and method for controlling powers of a main LCD and a sub LCD in a dual LCD mobile communication terminal. When the main LCD and the sub LCD share buses with each other, power is periodically supplied to the main LCD, which is powered off, in order to update the sub LCD. Accordingly, complexity of a folder due to the use of buffer can be solved. Further, when an LDI is used, unnecessary power consumption can be prevented.

This application claims priority under 35 U.S.C. § 119 to an application entitled “Apparatus And Method For Controlling Power Of Liquid Crystal Display In Mobile Communication Terminal” filed in the Korean Intellectual Property Office on Dec. 1, 2004 and assigned Ser. No. 2004-99670, the contents of which are incorporated herein by reference.

### BACKGROUND OF THE INVENTION

1. Field of the Invention

The present invention relates generally to an apparatus and method for controlling power of a liquid crystal display (LCD) in a mobile communication terminal, and more particularly, to an apparatus and method for controlling power of a main LCD and a sub LCD in a mobile communication terminal without using a buffer.

2. Background of the Prior Art

The use of mobile communication terminals is greatly increasing because of their portability. Additionally, in order to attract more users of mobile communication terminals, service providers (e.g., terminal manufacturers) have made attempts to develop different terminals with more diverse and special functions.

For example, using a conventional folder-type mobile communication terminal, the user cannot check a status of the terminal when a folder is closed. In order to solve that drawback, a dual LCD (Liquid Crystal Display) mobile communication terminal was developed. The dual LCD mobile communication terminal enables a user to check the terminal status on an external LCD without opening the folder.

FIGS. 1A and 1B are perspective views of a dual LCD mobile communication terminal according to the prior art, when the mobile communication terminal is closed and opened, respectively.

Referring to FIG. 1A, a dual LCD mobile communication terminal 100 includes a main body 102 and a sub body (or a folder) 104. A sub LCD 106 is installed at an outer side of the folder 104. The sub LCD 106 enables the user to check a status of the mobile communication terminal 100, even when the folder is closed.

Referring to FIG. 1B, a keypad assembly is installed in the main body 102. The keypad assembly has a navigation button at an upper portion thereof and commonly a plurality of numeric buttons at a lower portion thereof. A microphone is installed under the keypad assembly to convert sounds into electric signals. Although not illustrated in FIGS. 1A and 1B, a side key or side keys commonly provided at a side of the main body 102.

Additionally, a display with a main LCD 108 is installed on the folder 108, and an earpiece is installed above the display to convert electrical signals into sounds.

When the main LCD and the sub LCD share buses (e.g., data bus, control bus, address bus, etc.) with each other, power for each of the two LCDs can be controlled using an LCD driver integrated circuit (IC) (LDI) or a buffer as illustrated in FIG. 2.

The LDI is used to control the power of the LCD by setting a register of one of the two LCDs to a power down mode. The register is provided at a power controller of the LDI.

FIG. 2 is a block diagram illustrating a power control structure using the buffer in the dual LCD mobile communication terminal. For example, a power-off operation of the main LCD will be described below. Additionally, a power-off operation of the sub LCD can be achieved in the same manner.

Referring to FIG. 2, a microprocessor 200 controls a main LCD 202 and a sub LCD 204 using common buses (e.g., data bus, control bus, address bus). The main LCD 202 displays status information, restricted characters, moving pictures, and still pictures, which are generated during operation of the mobile communication terminal. Commonly, the sub LCD 204 displays time, battery bars, and Received Signal Strength Indication (RSSI) bars, thereby enabling the user to check the status of the mobile communication terminal even when the folder is closed.

A buffer 206 is disposed between the main LCD 202 and the sub LCD 204 for preventing distortion of data input to the sub LCD when the main LCD is off. That is, when the main LCD is off, the main LCD enters a floating state and thus distortion of data input to the sub LCD can be prevented using the buffer.

The two methods can prevent unnecessary power consumption by controlling the powers of the main LCD and the sub LCD. However, the method using the LDI has a problem of a sleep current power. That is, the power of the LDI is not completely off and the LDI mode changes to a state in which power consumption is less, so that the power is consumed little by little. Further, the method using the buffer has a problem in that the buffer increases the size of the folder, i.e., increases volume. That is, using 16-bit data buses, the buffer must be applied to twenty or more buses, including control buses. Consequently, the addition of components increases the folder in volume and the complexity of the mobile communication terminal.

### SUMMARY OF THE INVENTION

The present invention provides an apparatus and method for controlling powers of a main LCD and a sub LCD in a dual LCD mobile communication terminal without using a buffer.

According to an aspect of the present invention, there is provided a method for controlling powers of a first LCD and a second LCD in a dual LCD mobile communication terminal, in which the first LCD and the second LCD share buses with each other. The method includes the steps of: driving a timer that is periodically terminated, when a power of the first LCD is off; supplying a power to the first LCD for a predetermined time, when the timer is terminated; and updating information displayed on the second LCD, while the power is supplied to the first LCD.

According to another aspect of the present invention, there is provided an apparatus for controlling powers in a dual LCD mobile communication terminal. The apparatus includes: a first LCD; a timer that is periodically terminated when a power of the first LCD is off; a controller for supplying a power to the first LCD for a predetermined time when the timer is terminated; and a second LCD for updating information displayed thereon while the power is supplied to the first LCD.

### BRIEF DESCRIPTION OF THE DRAWINGS

The accompanying drawings, which are included to provide a further understanding of the invention and are incorporated in and constitute a part of this application, illustrate embodiment(s) of the present invention, and together with the description below serve to explain the principles of the present invention. In the drawings:

FIGS. 1A and 1B are perspective views illustrating a dual LCD mobile communication terminal according to the prior art;

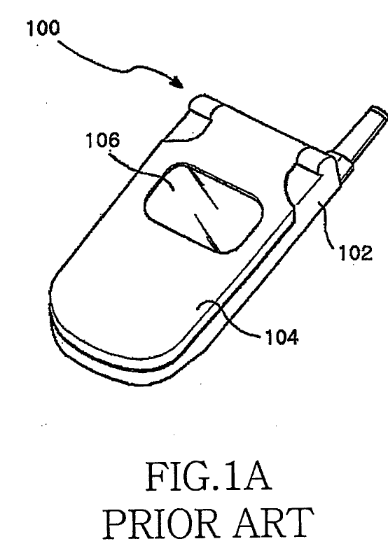

FIG. 2 is a block diagram illustrating an apparatus for controlling a power of a dual LCD in the dual LCD mobile communication terminal illustrated in FIG. 1;

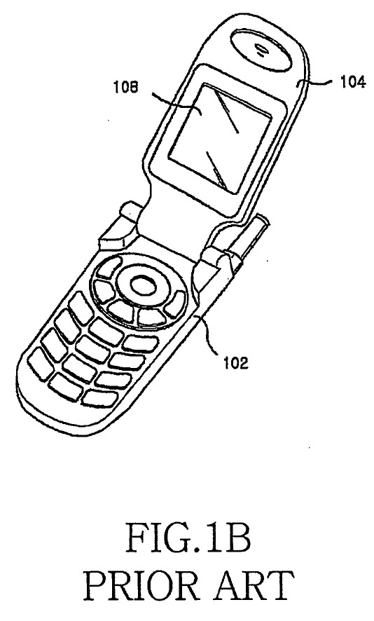

FIG. 3 is a block diagram illustrating a dual LCD mobile communication terminal according to an embodiment of the present invention;

FIG. 4 is a flowchart illustrating a method for controlling powers of a main LCD and a sub LCD in a dual LCD mobile communication terminal according to an embodiment of the present invention; and

FIG. 5 is a timing diagram illustrating a main LCD and a sub LCD in a dual LCD mobile communication terminal according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. A detail description of well-known features will be omitted for conciseness.

An apparatus and method for controlling powers of a main LCD and a sub LCD in a dual LCD mobile communication terminal will be described below with reference to the accompanying drawings.

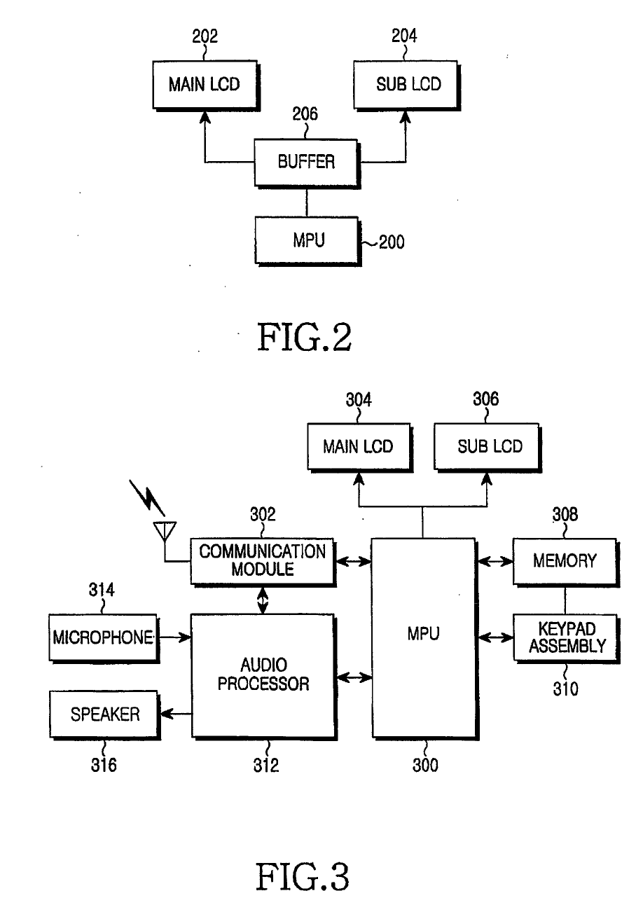

FIG. 3 is a block diagram of a dual LCD mobile communication terminal according to an embodiment of the present invention.

Referring to FIG. 3, a micro-process unit (MPU) 300 controls an overall operation of the mobile communication terminal. For example, the MPU 300 processes and controls voice communication and data communication. In addition to the typical functions, the MPU 300 controls powers of a main LCD 304 and a sub LCD 306. A description about the typical process and control operations of the MPU 300 will be omitted.

A communication module 302 processes transmission/reception of wireless data signals input/output through an antenna. For example, in data transmission, the communication module 302 performs a channel coding and spreading on the transmit data. In data reception, the communication module 302 converts a received RF signal into a baseband signal and performs a despreading and channel decoding on the baseband signal.

The main LCD 304 includes an LCD driver IC (LDI) and displays all information processed in the mobile communication terminal. The sub LCD 306 includes an LCD driver IC and displays time, battery bars, and RSSI bars. Accordingly, even when the folder is closed, the user can check the status of the mobile communication terminal.

A memory includes a program memory and a data memory. The program memory stores a program for controlling an overall operation of the mobile communication terminal. The data memory temporarily stores data that are created during the execution of the program.

A keypad assembly 310 preferably includes numeric keys of digits 0-9 and a plurality of function keys, such as a Menu key, a Cancel (Delete) key, an Enter key, a Talk key, an End key, an Internet connection key, Navigation keys (▴/▾/ [symbol] ), etc. The keypad assembly 310 provides a key input data to the MPU 300. The key input data corresponds to a key that is pressed by the user.

An audio processor 312, called a coder-decoder (CODEC), performs an input/output process of audio signals through a microphone 314 and a speaker 316. For example, the audio processor 312 converts digital data produced from the MPU 300 into analog audio signals. The analog audio signals are output through the speaker 316. Additionally, the audio processor 312 converts audio signals received through the microphone 314 into digital data and provides the digital data to the MPU 300.

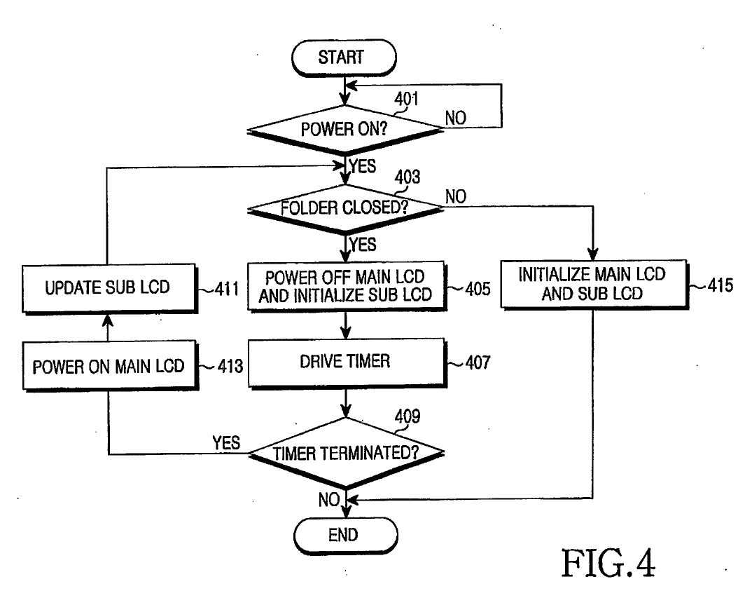

FIG. 4 is a flowchart illustrating a method for controlling powers of a main LCD and a sub LCD in a dual LCD mobile communication terminal according to an embodiment of the present invention. A power-off operation of the main LCD 304 will be described below. Further, a power-off operation of the sub LCD 306 can be achieved in the same manner.

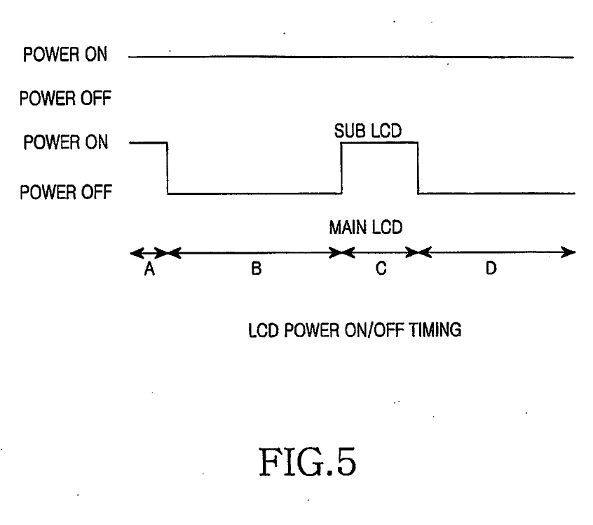

Referring to FIG. 4, in step 401, the MPU 300 determines if the mobile communication terminal is powered on. In step 403, when the power of the mobile communication terminal is on, the MPU determines if the folder of the mobile communication terminal is closed. In step 405, when the folder of the mobile communication terminal is not closed, i.e., open, the MPU supplies power to both the main LCD 304 and the sub LCD 306 (period A of FIG. 5). That is, in the booting of the mobile communication terminal, the main LCD 304 and the sub LCD 306 are supplied with power and display an initial status. Then, the MPU 300 ends this algorithm.

In step 405, when the folder of the mobile communication terminal is closed, the MPU 300 powers off the main LCD 304 and powers on the sub LCD 306 to display an initial status (period B of FIG. 5). More specifically, the power of the LDI to drive the main LCD 304 is completely off. In step 407, the MPU 300 drives a timer. When the power of the main LCD 304 is off, the timer operates to periodically supply the power to the main LCD and update the sub LCD 306.

In step 409, the MPU 300 determines if the timer is terminated. When the timer is not terminated, i.e., still running, the MPU 300 ends this algorithm. In steps 413 and 411, when the timer is terminated, the MPU 300 powers on the main LCD 304 for a predetermined time (period C of FIG. 5) and updates information displayed on the sub LCD 306. The process returns to step 403. That is, the MPU 300 determines if the power of the main LCD is off. When the power of the main LCD 304 is off, the main LCD 304 enters a floating state and influences data transmitted to the sub LCD 306, causing distortion of data transmitted to the sub LCD 306.

When the power of the main LCD 304 is on, the main LCD 304 enters a hi-impedance state and does not influence data transmitted to the sub LCD. Accordingly, after the main LCD 304 enters the hi-impedance state by periodically supplying the power to the main LCD 304, the sub LCD 306 is updated by transmitting data thereto.

As described above, without using additional parts, e.g., buffers, the dual LCD mobile communication terminal can control the powers of the two LCDs by periodically supplying the power to the LCD that is powered off. Therefore, while the prior art has a problem in that the folder becomes complex due to the use of the buffer, the complexity of the folder can be reduced. That is, the distortion of data in the LCD that is power on can be prevented by periodically supplying the power to the LCD that is powered off. Further, because the power of the LDI is completely off, it is possible to prevent unnecessary power consumption that is caused when the LDI is set to the power down mode.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for controlling powers of a first liquid crystal display (LCD) and a second LCD in a dual LCD mobile communication terminal, the first LCD and the second LCD sharing at least one bus with each other, the method comprising the steps of:
driving a timer that is periodically terminated when a power of the first LCD is off;
supplying power to the first LCD for a predetermined time when the timer is terminated; and
updating information displayed on the second LCD while the power is being supplied to the first LCD.

2. The method of claim 1, wherein the first LCD is a main LCD installed in an inner side of a folder of the mobile communication terminal, and the second LCD is a sub LCD installed in an outer side of the folder.

3. The method of claim 1, wherein the second LCD is a main LCD installed in an inner side of a folder of the mobile communication terminal, and the first LCD is a sub LCD installed in an outer side of the folder.

4. An apparatus for controlling power in a dual liquid crystal display (LCD) mobile communication terminal, the apparatus comprising:
a first LCD;
a timer that is periodically terminated when the first LCD is powered off;
a controller for supplying a power to the first LCD for a predetermined time when the timer is terminated; and
a second LCD that shares at least one bus with the first LCD for receiving updated information while the power is supplied to the first LCD.

5. The apparatus of claim 4, wherein the first LCD is a main LCD installed in an inner side of a folder in the mobile communication terminal to display all information processed therein, and the second LCD is a sub LCD installed in an outer side of the folder.

6. The apparatus of claim 5, wherein the sub LCD displays a battery bar, an RSSI (Received Signal Strength Indication) bar, and a time, enabling a user to check status of the mobile communication terminal when the folder is closed.

7. The apparatus of claim 4, wherein the second LCD is a main LCD installed in an inner side of a folder in the mobile communication terminal to display all information processed therein, and the first LCD is a sub LCD installed in an outer side of the folder.

8. The apparatus of claim 7, wherein the sub LCD displays a battery bar, an RSSI (Received Signal Strength Indication) bar, and a time, enabling a user to check status of the mobile communication terminal when the folder is closed.
